(19) United States
(12) Patent Application Publication
(10) Pub. No.: US 2024/0097195 A1
(43) Pub. Date: Mar. 21, 2024

(54) NONAQUEOUS ELECTROLYTE FOR LITHIUM-ION SECONDARY BATTERY AND LITHIUM-ION SECONDARY BATTERY

(71) Applicants: TOYOTA JIDOSHA KABUSHIKI KAISHA, Aichi-ken (JP); KANSAI PAINT CO., LTD., Hyogo-ken (JP)

(72) Inventors: Akira KOHYAMA, Aichi-ken (JP); Ryuta MORISHIMA, Aichi-ken (JP); Daisaku ITO, Kanagawa-ken (JP); Naoyuki IWATA, Kanagawa-ken (JP)

(73) Assignees: TOYOTA JIDOSHA KABUSHIKI KAISHA, Aichi-ken (JP); KANSAI PAINT CO., LTD., Hyogo-ken (JP)

(21) Appl. No.: 18/274,289

(22) PCT Filed: Jan. 27, 2022
(86) PCT No.: PCT/JP2022/002976

§ 371 Date: Jul. 26, 2023

(30) Foreign Application Priority Data
Jan. 29, 2021 (JP) 2021-013373

(51) Int. Cl. H01M 10/0569; H01M 10/0525

(52) U.S. Cl. CPC H01M 10/0569; H01M 10/0525; H01M 2300/0037

(57) ABSTRACT

A nonaqueous electrolyte for use in a lithium-ion secondary battery, capable of reducing gas generation due to degradation of nonaqueous electrolyte, is provided. The nonaqueous electrolyte disclosed herein is for use in a lithium-ion secondary battery wherein a negative electrode active material in a negative electrode includes at least one of a Si-based negative electrode active material including Si as a component and capable of reversibly absorbing and releasing lithium ions or a graphite-based carbon negative electrode active material. The nonaqueous electrolyte contains a nonaqueous solvent and an electrolyte dissolved in the nonaqueous solvent, and further contains a cyclic carbonate and a high-molecular-weight organic compound having a weight-average molecular weight of 1000 or higher.

### TECHNICAL FIELD

The present disclosure relates to a nonaqueous electrolyte for use in a lithium-ion secondary battery and a lithium-ion secondary battery including the same. The present application is based upon and claims the benefit of priority from Japanese patent application No. 2021-13373 filed on Jan. 29, 2021, and the entire disclosure of which is inorporated herein its entirety by reference.

### BACKGROUND ART

Since lithium-ion secondary batteries are lightweight and provide high energy density, they are used widely as portable power sources for personal computers, mobile terminals, and the like, and as power sources for driving vehicles such as battery electric vehicles (BEV), hybrid electric vehicles (HEV), and plug-in hybrid electric vehicles (PHEV).

In recent years, lithium-ion secondary batteries are expected to utilize Si-based negative electrode materials as negative electrode active materials in order to further increase capacity. Si-based materials are known to have a theoretical capacity density five times or more greater than graphite which is widely used as a negative electrode active material, and their application as a new negative electrode active material to replace graphite is consideration.

However, the negative electrode active material containing a Si-based material (hereinafter referred to as a Si-based anode active material) has a high theoretical capacity density, but has a property that its volume changes significantly during charging/discharging. Such a property may cause breakage or cracking in the Si-based negative electrode active material, resulting in isolation from the current collector network and reduction in battery life. Another disadvantage is that a solid electrolyte interphase (SEI) formed on the surface of the negative electrode active material cracks or is peeled, causing lithium ions in the electrolyte to be taken up for re-formation of the SEI, resulting in degradation of the nonaqueous electrolyte.

### CITATION LIST

### Patent Literatures

Patent Literature 1: Japanese Patent Application Publication No. 2014-002972
Patent Literature 2: Japanese Patent Application Publication No. 2008-071559
Patent Literature 3: Japanese Patent Application Publication No. 2007-027110
Patent Literature 4: Japanese Patent Application Publication No. 2004-525495
Patent Literature 5: Japanese Patent Application Publication No. 2016-532253

### SUMMARY OF INVENTION

Patent Literatures 1 to 4 disclose techniques of adding an additive to a nonaqueous electrolyte to improve battery life or to enhance battery safety. Patent Literature 5 discloses adding fluoroethylene carbonate to an electrolyte of a lithium-ion secondary battery including a carbon-based negative electrode active material and a Si-based negative electrode active material to improve battery life. Since fluoroethylene carbonate has an oxidation-reduction potential and is easily reduced and decomposed, SEI can be suitably formed and direct contact and reaction between the electrolyte and the active material can be prevented.

However, fluoroethylene carbonate has a problem of gas generation during SEI formation. Cyclic carbonates such as fluoroethylene carbonate and ethylene carbonate are prone to be a cause of gas generation during high temperature storage. Such gas generation may cause increase in internal pressure of the lithium-ion secondary battery. Thus, if the amount of gas generated increases due to use for a long period of time and leaving at high temperatures, the internal pressure may largely increase, and the battery life may be shorten due to deformation of the battery case, early activation of the pressure-sensitive safety mechanisms such as a current chopping mechanism and a safety valve. In addition, gas generation may inhibit sufficient permeation of the electrolyte, resulting in reduced battery performance. Therefore, technologies to suppress gas generation due to degradation of the nonaqueous electrolyte such as fluoroethylene carbonate are desired.

The present disclosure is intended to provide a nonaqueous electrolyte for use in a lithium-ion secondary battery, capable of suppressing gas generation due to degradation of the nonaqueous electrolyte. The present disclosure is intended to further provide a lithium-ion secondary battery using the nonaqueous electrolyte for use in a lithium-ion secondary battery.

The nonaqueous electrolyte disclosed herein is for use in a lithium-ion secondary battery wherein a negative electrode active material in a negative electrode includes at least one of an Si-based negative electrode active material including Si as a component and capable of reversibly absorbing and releasing lithium ions or a graphite-based carbon negative electrode active material. The nonaqueous electrolyte includes a nonaqueous solvent and an electrolyte dissolved in the nonaqueous solvent, and further contains a cyclic carbonate and a high-molecular-weight organic compound having a weight-average molecular weight of 1000 or higher.

Such a configuration allows suppression of gas generation due to degradation of the nonaqueous electrolyte and improvement in battery life (capacity retention rate) of the lithium secondary battery.

In a preferred aspect of the nonaqueous electrolyte disclosed herein, the cyclic carbonate is at least one of ethylene carbonate (EC) or monofluoroethylene carbonate (FEC).

With such a configuration, SEI formation on the negative electrode active material occurs, and gas generation can be suppressed. This allows improvement in capacity retention rate.

In a preferred aspect of the nonaqueous electrolyte disclosed herein, a content of the ethylene carbonate (EC) is 5 mass % or higher and/or a content of the monofluoroethylene carbonate (FEC) is 0.1 mass % or higher relative to 100 mass % of the nonaqueous electrolyte.

With such a configuration, gas generation can be suitably suppressed, and the capacity retention rate of the lithium-ion secondary battery can be further improved.

In a preferred aspect of the nonaqueous electrolyte disclosed herein, a content of the high-molecular-weight organic compound is 0.01 mass % to 10 mass % relative to the nonaqueous electrolyte.

With such a content of the high-molecular-weight organic compound, the capacity retention rate of the lithium-ion secondary battery can be suitably improved.

In a preferred aspect of the nonaqueous electrolyte disclosed herein, the high-molecular-weight organic compound has a polar functional group, the polar functional group is at least one selected from the group consisting of an amino group, a sulfonate group, a carboxyl group, a phosphate group, a polyalkylene ether group, an amide group, a hydroxyl group, an epoxy group, and an alkoxysilyl group, and a concentration of the polar functional group in the high-molecular-weight organic compound is 0.1 mmol/g or higher.

With such a configuration, stability of the high-molecular-weight organic compound in the nonaqueous electrolyte increases, and the high-molecular-weight organic compound is easily adsorbed to the negative electrode active material. This allows improvement in capacity retention rate.

In a preferred aspect of the nonaqueous electrolyte disclosed herein, the high-molecular-weight organic compound contains a copolymer compound of a polymerizable unsaturated monomer.

With such a configuration, stability of the high-molecular-weight organic compound in the nonaqueous electrolyte increases, and the high-molecular-weight organic compound is easily adsorbed to the negative electrode active material. This allows further improvement in capacity retention rate.

The lithium-ion secondary battery disclosed herein includes: an electrode assembly including a negative electrode, a positive electrode, and a separator; and a nonaqueous electrolyte for the lithium-ion secondary battery.

With such a configuration, a lithium-ion secondary battery with suppressed gas generation due to degradation of the nonaqueous electrolyte and improved capacity retention rate can be provided.

### BRIEF DESCRIPTION OF DRAWINGS

FIG. 1 is a schematic section view of an internal structure of a lithium-ion secondary battery using a nonaqueous electrolyte according to an embodiment.

FIG. 2 is a schematic view of a configuration of a wound electrode assembly of a lithium-ion secondary battery using a nonaqueous electrolyte according to the embodiment.

### DESCRIPTION OF EMBODIMENTS

An embodiment of the present disclosure will be described below. The matters necessary for executing the present disclosure, except for matters specifically herein referred to can be grasped as design matters of a person skilled in the art based on the related art in the preset field. The disclosure can be executed based on the contents disclosed herein and the technical knowledge in the present field.

The expression “A to B (here A and B are any numerical values)” indicating herein a numerical range means “from A to B inclusive,” which is the same as the general meaning.

The “secondary battery” herein indicates an electricity storage device that can be repeatedly charged and discharged, and encompasses so-called secondary batteries and electricity storage elements such as electric double-layer capacitors. The “lithium-ion secondary battery” herein indicates a secondary battery which uses lithium ions as electric charge carriers and achieves charging and discharging by movement of electric charges associated with the lithium ions between positive and negative electrodes.

When the high-molecular-weight organic compound (resin) contains a monomer X as its raw material herein, the high-molecular-weight organic compound (resin) is a (co)polymer of the raw material monomer including the monomer X. The (co)polymer herein means a polymer or copolymer.

The “(meth)acrylate” herein means acrylate and/or methacrylate, and “(meth)acrylic acid” herein means acrylic acid and/or methacrylic acid. Further, “(meth)acryloyl” means “acryloyl” and/or methacryloyl. The “(meth)acrylamide” means acrylamide and/or methacrylamide.

The nonaqueous electrolyte for use in a lithium-ion secondary battery according to the present embodiment includes: a nonaqueous solvent including a cyclic carbonate solvent; and an electrolyte dissolved in the nonaqueous solvent, and further contains a high-molecular-weight organic compound having the following weight-average molecular weight of 1000 or higher.

<High-Molecular-Weight Organic Compound>

The weight-average molecular weight of the high-molecular-weight organic compound which can be used in the present disclosure is usually 1000 or higher, preferably within a range from 1000 to 100000, more preferably from 2000 to 50000, yet more preferably from 3000 to 30000 in light of the battery capacity retention rate.

The number average molecular weight and the weight average molecular weight herein are obtained by converting the retention time (retention volume) of polystyrene measured by gel permeation chromatograph (GPC) into the molecular weight of the polystyrene by the retention time (retention volume) of standard polystyrene with known molecular weight, measured under the same conditions. Specifically, “HLC8120GPC” (trade name, manufactured by Tosoh) is used as the gel permeation chromatograph, and four columns of “TSKgel G-4000HXL,” “TSKgel G-3000HXL,” “TSKgel G-2500HXL,” and “TSKgel G-2000HXL” (trade names, all manufactured by Tosoh) are used as columns, and measurements can be performed under conditions where the mobile phase is tetrahydrofuran, the measurement temperature is 40° C., the flow rate is 1 mL/min, and the detector is RI.

The type of the high-molecular-weight organic compound is not particularly limited, specific examples thereof include acrylic resin, polyester resin, epoxy resin, polyether resin, alkyd resin, urethan resin, silicone resin, polycarbonate resin, silicate resin, chlorine-based resin, fluorine-based resin, polyvinyl alcohol, polyvinyl acetal, polyvinylpyrrolidone, and composite resins thereof, and one type of them may be used alone, or two or more types of them may be used in combination.

In particular, in light of the battery capacity retention (including stability in the nonaqueous electrolyte and adsorbability to the negative electrode active material), stability in the negative electrode mixture paste, adsorbability to the negative electrode active material, and the like, the high-molecular-weight organic compound preferably has a polar functional group, and the polar functional group is preferably at least one polar functional group selected from the group consisting of an amino group, a sulfonate group, a carboxyl group, a phosphate group, a polyalkylene ether group, an amide group, a hydroxyl group, an epoxy group, and an alkoxysilyl group.

The concentration of the polar functional group in the high-molecular-weight organic compound is usually 0.1 mmol/g or higher, preferably 1 mmol/g to 30 mmol/g, more preferably 2 mmol/g to 25 mmol/g, yet more preferably 5 mmol/g to 22 mmol/g in light of the battery capacity retention rate.

In particular, the concentration of an ionic polar functional group is usually 0.1 mmol/g or higher, preferably 0.2 mmol/g to 25 mmol/g, more preferably 0.3 mmol/g to 10 mmol/g in light of the battery capacity retention.

The concentration of the polar functional group herein is calculated based on the number of the polar functional group in the polymerizable unsaturated monomer.

For example, when one polymerizable unsaturated monomer has two polar functional groups, the concentration of the polar functional groups is calculated based on the two polar functional groups.

The high-molecular-weight organic compound is preferably a hydrophilic (highly-polar) compound by the polar functional group, and is preferably soluble in water. The expression “being soluble in water” herein encompasses the meaning that when mixed in water to make an aqueous 5% solution, it is in a dissolved or semi-dissolved state, not in an emulsified state. It should be noted that the expression “being soluble in water” indicates a preferred property of the high-molecular-weight organic compound, and is not intended to indicate that the electrolyte in the lithium-ion secondary battery according to the present embodiment suitably includes water.

In particular, in light of the battery capacity retention (including stability in the nonaqueous electrolyte and adsorbability to the negative electrode active material), stability in the negative electrode mixture paste, adsorbability to the negative electrode active material, the high-molecular-weight organic compound preferably contains a copolymer compound of a polymerizable unsaturated monomer.

<Copolymer Compound>

As a polymerizable unsaturated monomer used as a raw material of the copolymer compound, any monomer having a polymerizable unsaturated group that can undergo radical polymerization can be used without particular limitations. Examples of the polymerizable unsaturated group include a (meth)acryloyl group, a (meth)acrylamide group, a vinyl group, an allyl group, a (meth)acryloyloxy group, and a vinylether group.

In particular, the copolymer compound preferably contains a copolymer of a polymerizable unsaturated monomer having a polar functional group as a component.

<Polymerizable Unsaturated Monomer having Polar Functional Group>

Examples of the polymerizable unsaturated monomer having the polar functional group which is at least one selected from the group consisting of an amino group, a sulfonate group, a carboxyl group, a phosphate group, a polyalkylene ether group, an amide group, a hydroxyl group, an epoxy group, and an alkoxysilyl group. Examples of the polymerizable unsaturated monomer include hydroxyl group-containing polymerizable unsaturated monomers such as monoesterified products of (meth)acrylic acid such as 2-hydroxyethyl (meth)acrylate, 2-hydroxypropyl (meth)acrylate, 3-hydroxypropyl (meth)acrylate, and 4-hydroxybutyl (meth)acrylate and alcohol with 2 to 8 carbon atoms, ε-caprolactone denatured bodies of the monoesterified products of the (meth)acrylic acid and the alcohol with 2 to 8 carbon atoms, N-hydroxymethyl (meth)acrylamide, allyl alcohol, and (meth)acrylate having a polyoxyalkylene chain with a hydroxyl group at the molecular end; carboxyl group-containing polymerizable unsaturated monomers such as (meth)acrylic acid, maleic acid, crotonic acid, and β-carboxyethyl acrylate; amino group- and/or amide group-containing polymerizable unsaturated monomers such as (meth)acrylamide, N,N-dimethylaminoethyl (meth)acrylate, N,N-diethylaminoethyl (meth)acrylate, N,N-dimethylaminopropyl (meth)acrylamide, and adducts of glycidyl (meth)acrylate and amines; polymerizable unsaturated monomers having an urethan bond such as a reaction product of an isocyanate group-containing polymerizable unsaturated monomer and a hydroxyl group-containing compound or a reaction product of a hydroxyl group-containing polymerizable unsaturated monomer and an isocyanate group-containing compound; epoxy group-containing polymerizable unsaturated monomers such as glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate, and allyl glycidyl ether; (meth)acrylate having a polyoxyethylene chain with an alkoxy group at the molecular end; sulfonate group-containing polymerizable unsaturated monomers such as 2-acrylamide-2-methylpropanesulfonic acid, 2-sulfoethyl (meth)acrylate, allyl sulfonic acid, 4-styrene sulfonic acid, and sodium salts and ammonium salts of these sulfonic acids; phosphate group-containing polymerizable unsaturated monomers such as 2-acryloyloxyethyl acid phosphate, 2-methacryloyloxyethyl acid phosphate, 2-acryloyloxypropyl acid phosphate, and 2-methacryloyloxypropyl acid phosphate; alkoxysilyl group-containing polymerizable unsaturated monomers such as trimethoxyvinylsilane, vinyltriethoxysilane, vinyl tris(2-methoxyethoxy) silane, γ-(meth)acryloyloxypropyltrimethoxysilane, γ-(meth)acryloyloxypropyltrimethoxysilane; polyalkylene ether group-containing polymerizable unsaturated monomers represented by the following formula (1) such as polyethylene glycol (meth)acrylate, polypropylene glycol (meth)acrylate, methoxypolyethylene glycol (meth)acrylate, and ethoxypolyethylene glycol (meth)acrylate;

CH₂═C(R₁)COO(CₙH₂ₙO)ₘ—R₂ (1)

[In the formula (1), “R₁” represents a hydrogen atom or CH₃, “R₂” represents a hydrogen atom or an alkyl group with 1 to 4 carbon atoms, “m” is an integer of 4 to 60, particularly 4 to 55, and “n” is an integer of 2 to 3, wherein m oxyalkylene units (CₙH₂ₙO) may be the same or different from each other.]

These polymerizable unsaturated monomers may be used alone or in combination of two or more of them. In light of the battery capacity retention rate, the polymerizable unsaturated monomer preferably has an ionic functional group and/or polyalkylene ether group, more preferablyhas an ionic functional group.

<Other Polymerizable Unsaturated Monomer>

Examples of the polymerizable unsaturated monomer other than the polymerizable unsaturated monomer having the polymerizable unsaturated monomer include: alkyl or cycloalkyl (meth)acrylates such as alkyl (meth)acrylates with equal to or lower than 3 carbon atoms such as methyl (meth)acrylate, ethyl (meth)acrylate, n-propyl (meth)acrylate, and isopropyl (meth)acrylate, n-butyl (meth)acrylate, i-butyl (meth)acrylate, t-butyl(meth)acrylate, n-hexyl (meth)acrylate, octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methycyclohexyl (meth)acrylate, t-butylcyclohexyl (meth)acrylate, cycloldodecyl (meth)acrylate, and tricyclodecanyl (meth)acrylate; polymerizable unsaturated compounds having an isobornyl group such as isobornyl (meth)acrylate; polymerizable unsaturated compounds having an adamantyl group such as adamantyl (meth)acrylate; aromatic ring-containing polymerizable unsaturated monomers such as benzyl (meth)acrylate, styrene, α-methylstyrene, andvinyltoluene; and polymerizable unsaturated monomers having at least two polymerizable unsaturated groups in one molecule, such as allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butane diol di(meth)acrylate, neopentyl glycol di(meth)acrylate, 1,6-hexane diol di(meth)acrylate, pentaerythritol di(meth)acrylate, pentaerythritol tetra(meth)acrylate, glycerol di(meth)acrylate, 1,1,1-trishydroxymethylethane di(meth)acrylate, 1,1,1-trishydroxymethylethane tri(meth)acrylate, 1,1,1-trishydroxymethylpropane tri(meth)acrylate, triallyl isocyanurate, diallyl phthalate, and divinylbenzene. These polymerizable unsaturated monomers may be used alone or in combination of two or more of them.

<Polymerization Method>

The polymerization method for a copolymer compound can be a known method.

For example, the copolymer compound can be produced by solution polymerization of a polymerizable unsaturated monomer in an organic solvent without limitations, and for example, bulk polymerization, emulsion polymerization, or suspension polymerization can be used. When solution polymerization is performed, it may be continuous or batch polymerization, and the polymerizable unsaturated monomer may be used at once or divided and used individually, or added continuously or intermittently.

A radical polymerization initiator used for the polymerization can be a known polymerization method. Examples of the radical polymerization initiator include peroxide-based polymerization initiators such as cyclohexanone peroxide, 3,3,5-trimethyl cyclohexanone peroxide, methyl cyclohexanone peroxide, 1,1-bis(tert-butylperoxy)-3,3,5-trimethylcyclohexane, 1,1-bis(tert-butylperoxy)cyclohexane, n-butyl-4,4-bis(tert-butylperoxy)valerate, cumene hydroperoxide, 2,5-dimethylhexane-2,5-dihydroperoxide, 1,3-bis(tert-butylperoxy-m-isopropyl)benzene, 2,5-dimethyl-2,5-di(tertbutylperoxy)hexane, diisopropylbenzene peroxide, tert-butylcumyl peroxide, decanoyl peroxide, lauroyl peroxide, benzoyl peroxide,2,4-dichlorobenzoyl peroxide, di-tert-amyl peroxide, bis(tert-butylcyclohexyl)peroxy dicarbonate, tert-butylperoxy benzoate, 2,5-dimethyl-2,5-di(benzoylperoxy)hexane, and tert-butylperoxy-2-ethylhexanoate; azo-based polymerization initiators such as 2,2′-azobis(isobutyronitrile), 1,1-azobis(cyclohexane-1-carbonitril), azo cumene, 2,2′-azobis(2-methylbutylonitrile), 2,2′-azobis dimethylvaleronitrile, 4,4′-azobis(4-cyanovaleric acid), 2-(t-butylazo)-2-cyanopropane, 2,2′-azobis(2,4,4-trimethylpentane), 2,2′-azobis(2-methylpropane), and dimethyl 2,2′-azobis(2-methylpropionate). These polymerizable unsaturated monomers may be used alone or in combination of two or more of them.

A solvent used for polymerization is not particularly limited, and can be water, an organic solvent, or a mixture thereof. Examples of the organic solvent include: known solvents such as hydrocarbon solvents such as n-butane, n-hexane, n-heptane, n-octane, cyclopentane, cyclohexane, and cyclobutane; aromatic solvents such as toluene and xylene; ketone-based solvents such as methyl isobutyl ketone; ether-based solvents such as n-butylether, dioxane, ethylene glycol monomethyl ether, ethylene glycol monoethyl ether, ethylene glycol monobutyl ether, and diethylene glycol; ester-based solvents such as ethyl acetate, n-butyl acetate, isobutyl acetate, ethylene glycol monomethyl ether acetate, and butyl carbitol acetate; ketone-based solvents such as methyl ethyl ketone, methyl isobutyl ketone, and diisobutylketone; alcohol-based solvents such as ethanol, isopropanol, n-butanol, sec-butanol, and isobutanol; amide-based solvents such as Equamide (trade name, manufactured by Idemitsu Kosan Co., Ltd.), N,N-dimethylformamide, N,N-dimethylacetamide, N-methylformamide, N-methylacetamide, N-methylpropypamide, and N-methyl-2-pyrrolidone.

Among them, since the solvent is used in electrolyte, it preferably does not contain water, and preferably includes at least one carbonate-based solvent selected from the group consisting of diethyl carbonate, ethyl methyl carbonate, dimethyl carbonate, and propylene carbonate. These solvents may be used alone or in combination of two or more of them.

In the solution polymerization in an organic solvent, for example, used is a method in which a polymerization initiator, a polymerizable unsaturated monomer component, and an organic solvent are mixed and heated while stirring, or a method in which an organic solvent is introduced into a reaction vessel to reduce the temperature increase in the system due to reaction heat, and a polymerizable unsaturated monomer component and a polymerization initiator are then added drowise separately or in combination over a predetermined time with stirring at a temperature of 60° C. to 200° C. while optionally blowing in an inactive gas such as nitrogen and argon.

Polymerization can generally be performed for 1 hour to 10 hours. After each stage of polymerization, an additional catalyst stage of heating the reaction vessel while the polymerization initiator is added dropwise may be provided if necessary.

In light of adsorption to Si-based negative electrode active material and stability, the copolymer compound particularly preferably has a graft structure or block structure, which is divided into two segments, an adsorption part and a steric repulsion part, especially a graft structure (comb structure).

In light of compatibility with electrolyte, the graft structure has an ionic functional group in the adsorption part, which is a main chain, and a hydrophilic functional group in a steric repulsion part, which is a side chain.

The hydrophilic functional group in the side chain can be suitably an ionic functional group or a nonionic functional group, and the copolymer compound preferably has at least one nonionic functional group among them.

The steric repulsion part in the side chain has a weight-average molecular weight of preferably 200 to 30000, more preferably 300 to 10000, yet more preferably 400 to 10000.

The mass ratio between the main chain and the side chain is preferably 1/99 to 99/1, more preferably 5/95 to 95/5, yet more preferably 5/95 to 50/50.

A method for introducing a steric repulsion part as a side chain into the copolymer compound can be suitably a method known per se, and specific examples thereof include a method in which a polymerizable unsaturated group-containing macromonomer which is a side chain and another polymerizable unsaturated group-containing monomer are copolymerized by the above-mentioned polymerization method, and a method in which the polymerizable unsaturated group-containing monomer is copolymerized, and a compound which is a side chain is added.

The polymerizable unsaturated group-containing macromonomer can be produced by a method known per se. For example, Japanese Examined Patent Application Publication No. S43-11224 describes a method in which a carboxylate group is introduced into the end of the polymer chain using a chain-transfer agent such as mercaptopropionic acid in the process of producing a macromonomer, and glycidyl methacrylate is then added to introduce an ethylenically unsaturated group, thereby obtaining a macromonomer. Japanese Examined Patent Application Publication Nos. H6-23209 and H7-35411 disclose a method by catalyst chain transfer polymerization (CCTP) using a cobalt complex. Japanese Unexamined Patent Application Publication No. H7-002954 describes a method in which methacrylic acid is subjected to radical polymerization using, as an addition-fragmentation chain-transfer agent, 2,4-diphenyl-4-methyl-1-pentene, thereby obtaining a macromonomer.

The amount of the high-molecular-weight organic compound in the nonaqueous electrolyte for a lithium-ion secondary battery according to present embodiment is not particularly limited as long as the effect of the present disclosure is exhibited. However, if the amount is too small, it is difficult to obtain the effect of the present disclosure. Thus, the amount is typically 0.01 mass % to 10 mass %, preferably 0.1 mass % to 5 mass %, more preferably 0.6 mass % to 1.5 mass %, relative to 100 mass % of the electrolyte. Adding the high-molecular-weight organic compound within such a range of the amount can more effectively improve the capacity retention rate of the lithium-ion secondary battery in the charge-discharge cycle.

The nonaqueous electrolyte for a lithium-ion secondary battery according to the present embodiment may be obtained by dissolving or dispersing a supporting electrolyte (lithium salt) as an electrolyte in a nonaqueous solvent.

The type of the nonaqueous solvent is not particularly limited as long as it can dissolve the high-molecular-weight organic compound, and carbonates, ethers, esters, nitriles, sulfones, lactones, and the like, which are commonly used in an electrolyte for a lithium-ion secondary battery can be used. Among them, carbonates are preferable. Examples of the carbonates include cyclic carbonates such as ethylene carbonate (EC) and propylene carbonate (PC) and chain carbonates such as diethyl carbonate (DEC), dimethyl carbonate (DMC), and ethyl methyl carbonate (EMC). These carbonates may be used alone or in combination of two or more of them.

In the present disclosure, the term “nonaqueous electrolyte” refers to an electrolyte that contains substantially no water, and although it is preferable that the electrolyte contains as little water as possible, a very small amount of water may be mixed in from raw materials or air (in the production process), and in such cases, the water content can be usually within a range of 1 mass % or less, preferably 0.5 mass % or less, more preferably 0.1 mass % or less.

The nonaqueous electrolyte used for a lithium secondary battery according to the present embodiment is preferably ethylene carbonate (EC) among cyclic carbonates. Ethylene carbonate not only has a high relative permittivity, but is also involved in SEI formation and can improve stability and/or durability of the negative electrode. The effect is difficult to be shown if the content of the ethylene carbonate in the nonaqueous electrolyte is too low. Thus, the ethylene carbonate is contained in the nonaqueous electrolyte preferably in 5 mass % or higher, more preferably 15 mass % or higher, yet more preferably 25 mass % or higher.

As the lithium salt, various types of lithium salts used in commonly used lithium-ion secondary batteries can be selected and employed, as appropriate. For example, LiPF₆, LiBF₄, LiClO₄, LiAsF₆, Li(CFaSO₂)₂N, and LiCF₃SO₃ can be used. These lithium salts may be used alone or in combination of two or more of them. the concentration of the lithium salt used is preferably in the range from 0.7 mmol/L to 1.3 mol/L inclusive.

The nonaqueous electrolyte for use in a lithium-ion secondary battery according to the present embodiment may further include various additives as long as properties of the lithium-ion secondary battery is not impaired. Such additives can be used as a film-forming agent, a overcharging additive, and the like, for one or more of the following purposes: improvement in battery input/output characteristics, improvement in cycle characteristics, improvement in initial charge and discharge efficiency, and improvement in safety. Specific examples of the additives include film-forming agents such as lithium bis(oxalato)borate (LiBOB), vinylene carbonate (VC), vinylethylene carbonate (VEC), monofluoroethylene carbonate (FEC); overcharging additives consisting of compounds that can generate gas when overcharged, such as biphenyl (BP) and cyclohexylbenzene (CHB); surfactants; dispersants; thickeners; and anti-freeze agents. The concentrations of these additives in the total nonaqueous electrolyte vary depending on the types of the additives, but is usually about 0.1 mol/L or less (typically 0.005 mol/L to 0.05 mol/L) for the film-forming agent and usually about 6 mass % or less (typically 0.5 mass % to 4 mass %) for the overcharging additive.

Among the film-forming agents, monofluoroethylene carbonate (FEC) is preferably used in the nonaqueous electrolyte for use in a lithium-ion secondary battery according to the present embodiment. monofluoroethylene carbonate, which is a cyclic carbonate, facilitates SEI formation, and allows suitable protection of the negative electrode (e.g., suppression of gas generation due to degradation of the electrolyte). The amount of monofluoroethylene carbonate added to the nonaqueous electrolyte is preferably 0.1 mass % or higher, more preferably 0.5 mass % or higher, yet more preferably 1 mass % or higher. The upper limit of the amount is preferably 10 mass % or less, more preferably 4 mass % or less, yet more preferably 3 mass % or less.

The nonaqueous electrolyte for use in a lithium-ion secondary battery according to the present embodiment can be used in lithium-ion secondary batteries according to the known methods. The high-molecular-weight organic compound contained in the nonaqueous electrolyte for use in a lithium-ion secondary battery allows suppression of gas generation due to degradation of the nonaqueous electrolyte, thereby suppressing the reduction in capacity retention rate in charge-discharge cycles.

A schematic configuration example of the lithium-ion secondary battery using the nonaqueous electrolyte for use in a lithium-ion secondary battery according to the present embodiment will be described below with reference to the drawings. In the following drawings, the same members/portions which exhibit the same action are denoted by the same reference numeral. The dimensional relation (such as length, width, or thickness) in each drawing does not reflect the actual dimensional relation.

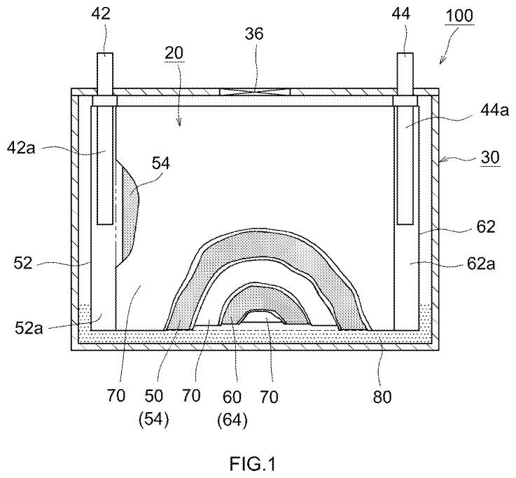

The lithium-ion secondary battery 100 shown in FIG. 1 is a sealed battery constructed by housing a flat wound electrode assembly 20 and an electrolyte 80 in a flat square battery case (i.e., an outer container) 30. The battery case 30 includes a positive electrode terminal 42 and negative electrode terminal 44 for external connection, and a thin-walled safety valve 36 set to release an internal pressure of the battery case 30 when the internal pressure increases to a predetermined level or higher. The battery case 30 is provided with an inlet (not shown) for introducing the electrolyte 80. The positive electrode terminal 42 is electrically connected to a positive electrode current collector 42a. The negative electrode terminal 44 is electrically connected to a negative electrode current collector 44a. As the material of the battery case 30, a metal material which is light and has high thermal conductivity, such as aluminum can be used, for example.

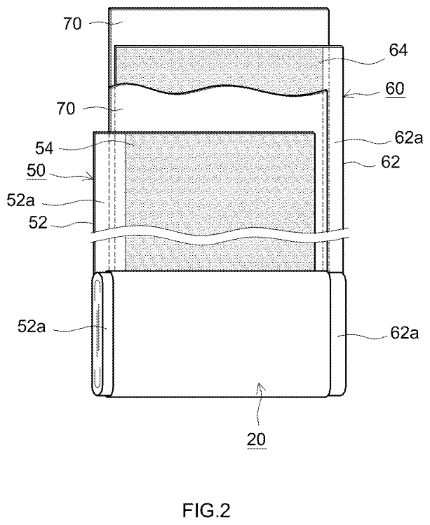

As shown in FIGS. 1 and 2, the wound electrode assembly 20 has a configuration in which a sheet-like positive electrode 50 in which a positive electrode active material layer 54 is provided on one or both surfaces of a long positive electrode current collector 52 along the longitudinal direction and a negative electrode 60 in which a negative electrode active material layer 64 is provided on one or both surfaces of a long negative electrode current collector 62 along the longitudinal direction are stacked on each other via two long separators 70 in the longitudinal direction. A positive electrode current collector 42a and a negative electrode current collector 44a are bonded to a portion 52a where the positive electrode active material layer is not formed (i.e., a portion where the positive electrode active material layer 54 is not formed and the positive electrode current collector 52 is exposed) and a portion 62a where the negative electrode active material layer is not formed (i.e., a portion where the negative electrode active material layer 64 is not formed and the negative electrode current collector 62 is exposed) formed to extend outward from both ends of the wound electrode assembly 20 in the winding axis direction (i.e., the sheet width direction orthogonal to the longitudinal direction).

Examples of the positive electrode collector foil 52 constituting the positive electrode 50 include an aluminum foil. Examples of the positive electrode active material included in the positive electrode active material layer 54 include lithium transition metal oxide (such as LiNi_{1/3}Co_{1/3}Mn_{1/3}O₂, LiNiO₂, LiCoO₂, LiFeO₂, LiMn₂O₄, LiNi_{0.5}Mn_{1.5}O₄) and lithium transition metal phosphate compound (such as LiFePO₄).

The positive electrode active material layer 54 may further contain, for example, a component such as an electroconductive material and a binder, besides the active material. The electroconductive material suitably used may be, for example, carbon black such as acetylene black (AB) and other carbon materials (e.g., graphite). The binder used may be, for example, polyvinylidene fluoride (PVdF).

Examples of the negative electrode current collector 62 constituting the negative electrode 60 include a copper foil. As the negative electrode active material contained in the negative electrode active material layer 64, graphite-based carbon material, lithium titanate (Li₄Ti₅O₁₂: LTO), Sn, a Si-based material, or the like can be used. The negative electrode active material includes at least one of the Si-based material or the graphite-based carbon material. In light of increasing the capacity of the lithium-ion secondary battery 100, a Si-based negative electrode active material containing Si as a component and capable of reversibly storing and releasing lithium ions is selected as the negative electrode active material in the negative electrode. As the Si-based negative electrode active material, for example, SiO or Si can be used. The “graphite-based carbon material” herein is a generic term for carbon materials consisting of graphite and carbon materials containing graphite of 50 mass % or higher (typically, 80 mass % or higher, for example, 90 mass % or higher).

These components of the negative electrode active material may be used alone or in combination of two or more of them. In light of increasing the capacity and suppressing the decrease in capacity retention rate of the lithium-ion secondary battery 100, a negative electrode active material containing a Si-based material and a graphite-based carbon material can be used, for example. For example, the negative electrode active material contains the Si-based material in a proportion of 0.01 mass % to 20 mass % and the graphite-based carbon material in a proportion of 50 mass % or higher, relative to 100 mass % of the negative electrode active material layer.

The negative electrode active material layer 64 may further contain, for example, a component such as a binder and a thickener, besides the active material. Examples of the binder used include styrene-butadiene rubber (SBR). Examples of the thickener used include carboxymethyl cellulose (CMC).

Examples of the separator 70 include porous sheets (films) made of resin such as polyethylene (PE), polypropylene (PP), polyester, cellulose, and polyamide. Such a porous sheet may have a monolayer structure, or a lamination structure of two or more layers (e.g., a three-layer structure where PP layers are stacked on both surfaces of a PE layer). The surface of the separator 70 may be provided with a heat-resistant layer (HRI).

As the electrolyte 80, the nonaqueous electrolyte for a lithium-ion secondary battery disclosed herein is used. Note that FIG. 1 does not show the exact amount of the electrolyte 80 injected into the battery case 30.

The lithium-ion secondary battery 100 configured as described above can be used for various applications. Suitable applications include power sources for driving, to be mounted on vehicles such as electric vehicles (BEV), hybrid vehicles (HEV), and plug-in hybrid vehicles (PHEV). Typically, the multiple lithium-ion secondary batteries 100 used may be connected in series and/or parallel to be in an assembled battery.

The square lithium-ion secondary battery 100 including the flat wound electrode assembly 20 has been described above as an example. However, the lithium-ion secondary battery can be configured as a lithium-ion secondary battery including a laminated electrode assembly. The lithium-ion secondary battery may also be configured as a cylindrical lithium-ion secondary battery or a laminated lithium-ion secondary battery.

The present disclosure will be further described by the following Examples.

Methods known in the art are used as synthesis methods for various compounds, production methods for secondary batteries, evaluation test methods, and the like. However, it should be understood that the present disclosure is not limited to this, and various modifications and variations are possible within the equivalent range of the technical idea and the scope of the claims of the present disclosure.

The term “parts” herein indicates parts by mass, and the symbol “%” indicates mass %.

<Production of Macromonomer>

(Macromonomer 1)

To a reaction container equipped with a thermometer, a condenser, a nitrogen gas introduction tube, a stirrer, and a dropper, 16 parts of ethylene glycol monobutyl ether and 9.15 parts of 2,4-diphenyl-4-methyl-1-pentene were introduced, and the resultant mixture was then stirred at 160° C. while nitrogen was blown in. Next, a mixture liquid of 100 parts of methacrylamide and 7 parts of di-tertiaryamylperoxide was added dropwise into the resultant mixture over a period of 3 hours, and the mixture was then stirred as it was for 2 hours. Subsequently, the mixture was cooled to 30° C. and diluted with diethyl carbonate, thereby obtaining a hydrophilic macromonomer containing a polymerizable unsaturated group (macromonomer 1) solution with a solid content of 60%. The obtained macromonomer 1 had a weight average molecular weight of 2000 and a concentration of the polar functional group of 11.8 mmol/g.

<Production of High-Molecular-Weight Organic Compound>

(High-Molecular-Weight Organic Compound No. 4)

To a reaction container equipped with a thermometer, a condenser, a nitrogen gas introduction tube, a stirrer, substitution a dropper, 40 parts of diethyl carbonate was introduced, and air in the reaction container was then replaced with nitrogen and then held at 120° C. To this reaction container, the following monomer mixture was added dropwise over a period of 4 hours.

### (Monomer Mixture)

methyl methacrylate: 25 parts
n-butyl acrylate: 25 parts
2-hydroxyethyl acrylate: 50 parts
t-butylperoxy-2-ethylhexanoate (polymerization initiator): 9 parts

After one hour from the end of the dropwise addition, a solution of 0.5 part of t-butylperoxy-2-ethylhexanoate dissolved in 10 parts of diethylcarbonate was added dropwise to the reaction container over a period of 1 hour. After the dropwise addition, the reaction container was held at 120° C. for another 1 hour. Diethyl carbonate was then added so that the solid content became 50%, thereby obtaining a high-molecular-weight organic compound No. 4 with a solid content of 50%. The high-molecular-weight organic compound No. 4 had a weight-average molecular weight of 4000 and a concentration of polar functional group of 4.3 mmol/g.

(High-Molecular-Weight Organic Compounds Nos. 5 to 15)

High-molecular-weight organic compounds Nos. 5 to 15 were produced in the same manner as for the high-molecular-weight organic compound No. 4 except that the composition of monomers and the polymerization initiators were as shown in the following Table 1.

Table 1 shows the weight-average molecular weight, the concentration of the polar functional group (mmol/g) and the concentration of ionic polar functional group (mmol/g) of each resin.

TABLE 1

| High-molecular-weight | | | | | | | | | |
|---|---|---|---|---|---|---|---|---|---|
| organic compound No. | | 1 | 2 | 3 | 4 | 5 | 6 | 7 | 8 |
| Monomer | Macromonomer 1 | Note 3 | Note 4 | Note 5 | | | | | |
| (parts) | (Note 1) | | | | | | | | |
| | Macromonomer 2 | | | | | | | | |
| | (Note 2) | | | | | | | | |
| | Methyl methacrylate | | | | 25 | 40 | 40 | 40 | 35 |
| | n-Butyl acrylate | | | | 25 | 40 | 40 | 40 | 35 |
| | 2-Hydroxyethyl | | | | 50 | | | | |
| | ethyl acrylate | | | | | | | | |
| | N,N- | | | | | | | 20 | |
| | Dimethylaminoethyl | | | | | | | | |
| | methacrylate | | | | | | | | |
| | Acrylic acid | | | | | 20 | 20 | | |
| | 2-Sulfoethyl acrylate | | | | | | | | 30 |
| | Methacryloyloxyethyl | | | | | | | | |
| | acid phosphate | | | | | | | | |
| t-Butylperoxy-2- | | | | | 9 | 9 | 4 | 4 | 4 |
| ethylhexanoate (parts) | | | | | | | | | |
| Weight-average molecular weight | | 2000 | 4000 | 4000 | 4000 | 4000 | 10000 | 10000 | 10000 |
| Concentration (mmol/g) of | | 22.7 | 22.7 | 14.1 | 4.3 | 2.8 | 2.8 | 1.3 | 1.5 |
| polar functional group | | | | | | | | | |
| Concentration (mmol/g) of | | 0 | 0 | 0 | 0 | 2.8 | 2.8 | 1.3 | 1.5 |
| ionic polar functional group | | | | | | | | | |
| High-molecular-weight | | | | | | | | | |
| organic compound No. | | 9 | 10 | 11 | 12 | 13 | 14 | 15 | 16 |
| Monomer | Macromonomer 1 | | 50 | | | | 50 | 50 | Note 6 |
| (parts) | (Note 1) | | | | | | | | |
| | Macromonomer 2 | | | 50 | 25 | 50 | | | |
| | (Note 2) | | | | | | | | |
| | Methyl methacrylate | 35 | 10 | 25 | 45 | | | | |
| | n-Butyl acrylate | 35 | 40 | 25 | 30 | 30 | 30 | 30 | |
| | 2-Hydroxyethyl | | | | | | | | |
| | ethyl acrylate | | | | | | | | |
| | N,N- | | | | | 20 | | | |
| | Dimethylaminoethyl | | | | | | | | |
| | methacrylate | | | | | | | | |
| | Acrylic acid | | | | | | 20 | 20 | |
| | 2-Sulfoethyl acrylate | | | | | | | | |
| | Methacryloyloxyethyl | 30 | | | | | | | |
| | acid phosphate | | | | | | | | |

| | | | | | | | | |
|---|---|---|---|---|---|---|---|---|
| t-Butylperoxy-2- | 4 | 4 | 4 | 4 | 4 | 4 | 0.5 | |
| ethylhexanoate (parts) | | | | | | | | |
| Weight-average molecular weight | 10000 | 10000 | 10000 | 10000 | 10000 | 10000 | 60000 | 500 |
| Concentration (mmol/g) of | 1.4 | 5.9 | 10.8 | 5.4 | 12.1 | 8.7 | 8.7 | 22.7 |
| polar functional group | | | | | | | | |
| Concentration (mmol/g) of | 1.4 | 0 | 0 | 0 | 1.3 | 2.8 | 2.8 | 0 |
| ionic polar functional group | | | | | | | | |

(Note 1)
Macromonomer 1: Macromonomer obtained by <Production of Macromonomer>
(Note 2)
Macromonomer 2: Methoxy polyethylene glycol methacrylate (molecular weight: 2000, concentration of polar functional group: 21.6 mmol/g)
(Note 3)
High-molecular-weight organic compound No. 1: Polyethylene glycol (100% of solid content)
(Note 4)
High-molecular-weight organic compound No. 2: Polyvinyl alcohol (99.9% of saponification value, 100% of solid content)
(Note 5)
High-molecular-weight organic compound No. 3: Polyacrylamide (100% of solid content)
(Note 6)
High-molecular-weight organic compound No. 16: Polyethylene glycol (100% of solid content) Numerical values in Table are amount of active ingredients.

<Production of Electrolyte>

### Example 1

To a solvent mixture of ethylene carbonate (EC) and ethyl methyl carbonate (EMC) at a volume ratio EC:EMC=30:70 as a nonaqueous solvent, 1.0 mol/L LiPF₆ which is an electrolyte was dissolved. Then, as a high-molecular-weight organic compound No. 1, “polyethylene glycol (the molecular weight: 2000, the concentration of functional group: 22.7 mmol/g, the solid content: 100%)” was mixed therein to account for 1 mass %, thereby producing an electrolyte (Example 1).

### Examples 2 to 14, 17 to 18, and 21 to 22

Electrolytes (Examples 2 to 14, 17 to 18, and 21 to 22) were produced in the same manner as in Example 1 except that high-molecular-weight organic compounds Nos. 2 to 16 were used instead of the high-molecular-weight organic compound No. 1 of Example 1 to be dissolved in the nonaqueous solvent.

### Examples 15 to 16 and 19 to 20

Electrolytes (Examples 15 to 16 and 19 to 20) were produced in the same manner as in Example 1 except that high-molecular-weight organic compounds Nos. 2 to 16 were used instead of the high-molecular-weight organic compound No. 1 of Example 1 to be dissolved in the nonaqueous solvent and after the dissolving, monofluoroethylene carbonate (FEC) was added to account for 1 mass %.

### Example 25

An electrolyte (Example 25) was produced in the same manner as in Example 1 except that the high-molecular-weight organic compound No. 1 of Example 1 was not dissolved.

### Examples 23 and 24

An electrolyte was produced in the same manner as in Example 25, and monofluoroethylene carbonate (FEC) was added thereto to account for the proportion shown in Table 2, thereby producing electrolytes (Examples 23 and 24).

Results of evaluation tests are shown in Table 2 to be described below. In this disclosure, an electrolyte was considered to be rejected if there was even one “X (Fail)” or “E (Fail)” result in the evaluation.

<Production of Lithium Ion Secondary Battery for Evaluation>

<Production of Positive Electrode>

A positive electrode active material (LiNi_{1/3}Co_{1/3}Mn_{1/3}O₂), an electroconductive auxiliary agent (acetylene black), a binder (PVdF) were mixed at a ratio of 87:10:3 (mass ratio) with N-methyl-2-pyrrolidone as a dispersion solvent, thereby producing a paste. The paste was then applied to an aluminum foil and dried, thereby producing a positive electrode plate.

<Production of Negative Electrode>

A powder mixture of graphite (a mean particle diameter: 20 μm) and SiO (a mean particle diameter: 15 μm) at a ratio of graphite:SiO=95:5 (mass ratio) as a negative electrode active material, a styrene-butadiene copolymer (SBR) as a binder, and carboxymethyl cellulose (CMC) as a thickener were mixed in a ratio of the powder mixture:SBR:CMC=98:1:1 (mass ratio) with water as a dispersion solvent, thereby producing a paste. The paste was then applied to a copper foil and dried, thereby producing a negative electrode.

<Production of Laminated Battery>

The positive electrode and the negative electrode were placed to face each other via a polypropylene/polyethylene/polypropylene trilayer porous film with an air permeability obtained by a Gurley permeability test of 300 seconds, thereby forming an electrode assembly, and the electrode assembly was then sealed with a laminate together with the electrolyte. Thus, a battery for evaluation was produced.

<Evaluation Test>

<Activation>

In a thermostatic chamber at 25° C., the initial charging was performed by the constant current method at a current value of 0.3 C up to 4.10 V, followed by discharging at a current value of 0.3 C up to 3.00 V by a constant current method. This was repeated a total of three times.

<Initial Capacity>

By the constant current-constant voltage method, charging was performed at a current value of 0.2 C up to 4.10 V, and low voltage charging was then performed until the current value in the charging at the constant voltage reaches 1/50 C. Thus, the secondary battery was fully charged. Thereafter, by the constant current method, discharging was performed at a current value of 0.2 C up to 3.00 V. The capacity at this time was determined as an initial capacity.

<Capacity Retention Rate (at 25° C.)>

In a thermostatic chamber set at 25° C., 500 cycles of charging and discharging were performed at a current value of 0.5 C. Charging set value was 4.10 V, and the discharging set value was 3.00 V. In addition, a 10-minute pause was provided after each end of the charging and discharging. Next, the capacity was measured after the cycle test, and the capacity retention rate was determined by the following equation.

Capacity retention rate (%)=(Battery capacity after 500 cycles/Initial capacity×100.

The evaluation was performed as follows.
A: The capacity retention rate was 99% or higher and 100% or less.
B: The capacity retention rate was 97% or higher and less than 99%.
C: The capacity retention rate was 94% or higher and less than 97%.
D: The capacity retention rate was 91% or higher and less than 94%.
E: The capacity retention rate was less than 91%.

<Capacity Retention Rate (at 60° C.)>

A capacity retention rate was measured in a thermostatic chamber set at 60° C. The measurement was performed in the same manner as for the capacity retention rate at 25° C. except that the temperature set for the thermostatic chamber was changed from 25° C. to 60° C.

<Gas Generation Amount>

The volume was measured by the Archimedes' method. A laminated battery was immersed in water at 25° C., and the volume of the laminated battery was measured from the change in mass. The volume was measured before and after the start of the 500 cycle test, and the gas generation amount was calculated by the following equation (2).

Gas generation amount (%)=(Volume after 500 cycles)−(Initial volume))×100 (2)

The evaluation was performed as follows.
Excellent: The gas generation amount was less than 60%.
Good: The gas generation amount was 60% or higher and less than 105%.
Not good: The gas generation amount was 105% or higher.

TABLE 2

| | | Amount of high- | | | | |
|---|---|---|---|---|---|---|
| | High-molecular- | molecular- | Amount of | Evaluation of | | Evaluation of |
| | weight organic | weight organic | FEC | capacity retention rate | | gas generation |
| Example | compound | compound (%) | (%) | 25° C. | 60° C. | amount |
| 1 | No. 1 | 1 | | D | D | Good |
| 2 | No. 2 | 1 | | C | D | Good |
| 3 | No. 3 | 1 | | C | D | Good |
| 4 | No. 4 | 1 | | C | D | Good |
| 5 | No. 5 | 1 | | C | C | Good |
| 6 | No. 6 | 1 | | C | C | Good |
| 7 | No. 7 | 1 | | C | C | Good |
| 8 | No. 8 | 1 | | C | C | Good |
| 9 | No. 9 | 1 | | C | C | Good |
| 10 | No. 10 | 1 | | C | C | Good |
| 11 | No. 11 | 1 | | C | C | Good |
| 12 | No. 12 | 1 | | C | C | Good |
| 13 | No. 13 | 1 | | B | B | Excellent |
| 14 | | 0.5 | | B | C | Excellent |
| 15 | | 1 | 1 | A | A | Excellent |
| 16 | | 0.5 | 1 | A | A | Good |
| 17 | No. 14 | 1 | | B | B | Excellent |
| 18 | | 0.5 | | B | C | Excellent |
| 19 | | 1 | 1 | A | A | Excellent |
| 20 | | 0.5 | 1 | A | A | Good |
| 21 | No. 15 | 1 | | B | C | Excellent |
| 22 | No. 16 | 1 | | D | E | Good |
| 23 | No addition | | 1 | B | B | Not Good |
| 24 | No addition | | 0.5 | C | C | Not Good |
| 25 | No addition | | | E | E | Good |

As can be seen from Table 2, Examples 1 to 21 in which any of the high-molecular-weight organic compounds Nos. 1 to 15 with a weight-average molecular weight of 1000 or higher showed improved capacity retention rate compared to Example 25. However, Example 22 in which the high-molecular-weight organic compound No. 16 with a weight-average molecular weight of 500 was added showed improved capacity retention rate at 25° C. and did not show improved capacity retention rate at 60° C. Examples 13 to 21 in which any of the high-molecular-weight organic compounds Nos. 13 to 15 were added showed suitably suppressed gas generation amounts compared to Example 25.°

Comparison among Examples 23 to 25 showed that the monofluoroethylene carbonate (FEC) added improved the capacity retention rate, but increased the gas generation amount. Comparison among Examples 15 to 16, 19 to 20, and 23 showed that the high-molecular-weight organic compound No. 13 or 14 added improved the capacity retention rate, but reduced the gas generation amount. The gas generation amount was further reduced when the amount of the high-molecular-weight organic compound No. 13 or 14 added was 1 mass % compared to when the amount was 0.5 mass %.

Although specific examples of the present disclosure have been described in detail above, they are mere examples and does not limit the appended claims. The technology described is the appended claims include various modifications and changes of the foregoing specific examples.

1. A nonaqueous electrolyte for a lithium-ion secondary battery wherein a negative electrode active material in a negative electrode includes at least one of a Si-based negative electrode active material including Si as a component, which is capable of reversibly absorbing and releasing lithium ions, or a graphite-based carbon negative electrode active material, the nonaqueous electrolyte comprising:
a nonaqueous solvent;
an electrolyte dissolved in the nonaqueous solvent;
a cyclic carbonate; and
a high-molecular-weight organic compound having a weight-average molecular weight of 1000 or higher.

2. The nonaqueous electrolyte according to claim 1, wherein the cyclic carbonate is at least one of ethylene carbonate (EC) or monofluoroethylene carbonate (FEC).

3. The nonaqueous electrolyte according to claim 1, wherein
the nonaqueous electrolyte includes ethylene carbonate (EC) in an amount of 5 mass % or higher and/or monofluoroethylene (FEC) in an amount of 0.1 mass % or higher relative to 100 mass % of the nonaqueous electrolyte.

4. The nonaqueous electrolyte according to claim 1, wherein
the nonaqueous electrolyte includes the high-molecular-weight organic compound in an amount of 0.01 mass % to 10 mass % relative to 100 mass % of the nonaqueous electrolyte.

5. The nonaqueous electrolyte according to claim 1, wherein
the high-molecular-weight organic compound has a polar functional group in an amount of 0.1 mmol/g or higher, and
the polar functional group is at least one selected from the group consisting of an amino group, a sulfonate group, a carboxyl group, a phosphate group, a polyalkylene ether group, an amide group, a hydroxyl group, an epoxy group, and an alkoxysilyl group.

6. The nonaqueous electrolyte according to claim 1, wherein the high-molecular-weight organic compound includes a copolymer compound of a polymerizable unsaturated monomer.

7. A nonaqueous electrolyte lithium-ion secondary battery comprising:
an electrode assembly including a negative electrode, a positive electrode, and a separator; and
the nonaqueous electrolyte according to claim 1.
